(19) United States
(12) Patent Application Publication
(10) Pub. No.: US 2012/0170129 A1
(43) Pub. Date: Jul. 5, 2012

(54) ANIMATED LENTICULAR DEVICE

(75) Inventor: Cameron Balian, Kensignton, MD (US)

(73) Assignee: MOTIONVUE LLC, Garrett Park, MD (US)

(21) Appl. No.: 12/985,146

(22) Filed: Jan. 5, 2011

(51) Int. Cl. G03B 25/02; G02B 27/12

(52) U.S. Cl. 359/626

(57) ABSTRACT

Disclosed are animated/active lenticular devices that are useful as animated entertainment and advertising devices. In one embodiment, the device is used in connection with an advertising button or card that can be attached to a product or article of clothing. Other uses include fixed displays, greeting cards, books, point-of-purchase displays, sporting event devices that can be worn on clothing or attached to the skin, and the like.

Embodiments of the invention relate to animated lenticular devices that are useful as animated entertainment and advertising devices. In one embodiment, the device is used in connection with an advertising button or card that can be attached to a product or article of clothing. Other uses include fixed displays, greeting cards, books, point-of-purchase displays, sporting event devices that can be worn on clothing or attached to the skin, and the like.

### DESCRIPTION OF RELATED ART

Lenticular mutli-image display devices generally are known. These known multi-image display devices consist of a planar, lenticular screen behind which, in a plane parallel to the screen, there is arranged a lithograph prepared from at least two different images, which appear alternatively to a stationary viewer whenever the position of the print is altered relative to the screen.

Methods for preparing such prints exist and are described, e.g., in U.S. Pat. Nos. 5,100,330 and 5,488,451, the disclosures of which are incorporated by reference herein in their entirety. The prior art methods, however, are very limited. When different kinds of displays are required, such as dynamic billboards, for example, these methods are not suitable. These methods also typically are designed for a definite product, and are mostly limited to small, passive-type devices, as opposed to dynamic displays.

A computerized image-processing method for creating lenticular multi-image display devices is described in U.S. Pat. No. 6,542,646, the disclosure of which is incorporated herein in its entirety. The method includes interlacing a plurality of images into a single document that can be positioned adjacent a lenticular screen and then each image viewed as the document or screen are moved relative to one another. Other lenticular displays are described in, for example, U.S. Pat. Nos. 6,219,948, 6,226,906, 6,286,239, 6,384,980, 6,624,947, 6,748,684, 7,210,257, 7,263,791, 7,312,926, and 7,383,651, the disclosures of each of which are incorporated by reference herein in their entireties.

As electronic articles such as the electronic trading cards (“ETC”) illustrated in U.S. Pat. No. 6,200,216 continue to set the standard for entertaining novelty items or greeting cards, there is an increasing demand to improve the animation quality of devices which do not rely upon the transmission of electronic data to convey a message or present an artistic work in an entertaining way. Animated greeting cards, which rely upon a mechanized actuator, are perhaps the most notable of these latter devices. Constraints in existing actuators used in such cards have been the primary reason they have not yet been able to convey a message, or display a character in a way that comes close to approximating the animation quality of articles such as the ETC.

Existing animation actuators suffer from numerous drawbacks: they are fragile; they consume power inefficiently, and they typically can only be used in one particular device configuration. The animated greeting card described in U.S. Pat. No. 5,139,454 (“'454 patent”) illustrates these drawbacks. The card disclosed in the '454 patent contains an actuator employing a bimetallic wire about 0.003 to 0.010 inches in diameter. This wire is affixed at one end to a circuit board and at the other to a gear. A Flexinol (Dynalloy) shape memory alloy (“SMA”) wire is disclosed in the '454 patent as one example of a useful wire. Upon application of electric current to the wire, the wire contracts thereby exerting a force on the gear which causes the gear to rotate The '454 patent discloses that a one inch long wire which is 3 millimeters in diameter can be activated by a pulsed current of about 0.75 volts at 6 ohms.

U.S. Pat. No. 6,848,965, the disclosure of which is incorporated by reference herein in its entirety, allegedly solves some of the problems of the '454 patent. This patent discloses an animated greeting card that can provide more than one image by movement of a display or lenticular screen relative to one another. The '965 patent uses a shape memory alloy wire and pulsed electrical current such that the wire expands and contracts, and by virtue of the expansion and contraction of the wire, moves the respective display or screen, as the case may be.

These devices often are expensive to manufacture, are comprised of expensive moving parts prone to breakage, and often are bulky. Accordingly, many of these devices are not suitable for use in mass marketing or advertising environments, in which the marketing or advertising device must be compact, lightweight, and inexpensive.

Accordingly, the need exists for animated lenticular devices that are adaptable to numerous animated entertainment devices, and that can provide an efficient use of power, be durable, and be adaptable to numerous configurations. There also is a need for animated devices that are lightweight, compact, and inexpensive to manufacture to facilitate their use in mass marketing campaigns and the like.

### SUMMARY OF THE INVENTION

It is therefore a feature of an embodiment of the invention to provide an animated lenticular device that can be used in a variety of environments, is lightweight, durable, compact, and inexpensive. It is an additional feature of an embodiment of the invention to provide a lightweight, compact animated device that can be placed on numerous products, on shelving units, on personal apparel, or printed on thin sheets and worn (or attached to a garment). These and other features will be readily apparent upon review of the detailed description of the preferred embodiments that follows.

In accordance with these and other features of embodiments of the invention, there is provided a device comprising a bottom surface, a control device positioned on or near the bottom surface, an actuator electrically coupled to the control device, the actuator comprised of at least one electroactive polymer capable of expanding or contracting in response to electrical current, one or more interlaced images attached to the actuator, and a lenticular lens positioned over the interlaced display.

In accordance with an additional feature of an embodiment of the invention, there is provided a method of displaying multiple images from one or more interlaced images comprising: (a) providing a device comprising a bottom surface, a control device positioned on or near the bottom surface, an actuator electrically coupled to the control device, the actuator comprised of at least one electroactive polymer capable of expanding or contracting in response to electrical current, one or more interlaced images attached to the actuator, and a lenticular lens positioned over the interlaced display; (b) providing current to the electroactive polymer to cause the polymer to expand and contract, whereby expansion and contraction of the polymer moves the one or more interlaced images relative to the lenticular lens to display multiple images through the lenticular lens.

These and other features of embodiments will be readily apparent from the detailed description that follows.

### DESCRIPTION OF THE DRAWINGS

FIG. 1 is an exploded view of a device in accordance with a preferred embodiment.

FIG. 2 is a side view of a device in accordance with a preferred embodiment.

FIG. 3 is a side view of the lenticular lens in accordance with a preferred embodiment of the invention.

### DETAILED DESCRIPTION OF PREFERRED EMBODIMENTS

The following definitions and non-limiting guidelines should be considered in reviewing the description of this invention set forth herein. The headings (such as “Background” and “Summary,”) used herein are intended only for general organization of topics within the disclosure of the invention, and are not intended to limit the disclosure of the invention or any aspect thereof. In particular, subject matter disclosed in the “Background” may include aspects of technology within the scope of the invention, and may not constitute a recitation of prior art. Subject matter disclosed in the “Summary” is not an exhaustive or complete disclosure of the entire scope of the invention or any embodiments thereof. Classification or discussion of a material within a section of this specification as having a particular utility (e.g., as being an “electroactive polymer” or a “lenticular lens”) is made for convenience, and no inference should be drawn that the material must necessarily or solely function in accordance with its classification herein when it is used in any given composition.

The citation of references herein does not constitute an admission that those references are prior art or have any relevance to the patentability of the invention disclosed herein. Any discussion of the content of references cited in the Background is intended merely to provide a general summary of assertions made by the authors of the references, and does not constitute an admission as to the accuracy of the content of such references.

The description and specific examples, while indicating embodiments of the invention, are intended for purposes of illustration only and are not intended to limit the scope of the invention. Moreover, recitation of multiple embodiments having stated features is not intended to exclude other embodiments having additional features, or other embodiments incorporating different combinations of the stated features. Specific Examples are provided for illustrative purposes of how to make and use the compositions and methods of this invention and, unless explicitly stated otherwise, are not intended to be a representation that given embodiments of this invention have, or have not, been made or tested.

As used herein, the words “preferred” and “preferably” refer to embodiments of the invention that afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention. In addition, the devices and the methods may comprise, consist essentially of, or consist of the elements described therein.

As used throughout, ranges are used as shorthand for describing each and every value that is within the range. Any value within the range can be selected as the terminus of the range. In addition, all references cited herein are hereby incorporated by reference in their entireties. In the event of a conflict in a definition in the present disclosure and that of a cited reference, the present disclosure controls.

Unless otherwise specified, all percentages and amounts expressed herein and elsewhere in the specification should be understood to refer to percentages by weight. The amounts given are based on the active weight of the material. The recitation of a specific value herein, whether referring to respective amounts of components, or other features of the embodiments, is intended to denote that value, plus or minus a degree of variability to account for errors in measurements. For example, an amount of 10 may include 9.5 or 10.5, given the degree of error in measurement that will be appreciated and understood by those having ordinary skill in the art.

Embodiments of the invention include a device 10 comprising a bottom surface 60, a control device 70 positioned on or near the bottom surface, an actuator 50 electrically coupled to the control device 70, the actuator comprised of at least one electroactive polymer capable of expanding or contracting in response to electrical current, one or more interlaced images 40 attached to the actuator, and a lenticular lens 30 positioned over the interlaced images 40. The device 10 also may include a housing 20 that encompasses the components of the device, may be connected to the bottom surface 60, and preferably includes a window or viewing pane that enables a user to view images through lenticular lens 30.

The bottom surface 60 or back plate, may be a bottom surface of the control device 70, or may be a separate component, such as a bottom portion of housing 20. The bottom surface may be made from the same or different materials than control device 70, or housing 20, and includes thermoplastics, metals, wood, cardboard, paper, elastomeric materials, plastics, glass, ceramics, and the like. It is preferred that the bottom surface 60 be comprised of a plastic material capable of being molded in an injection molding or thermoforming operation. Preferred plastics include, but are not limited to poly(meth)acrylate; polyamide; polyurethane; polyolefins (e.g., polypropylene, polyethylene, polybutylene, copolymers and terpolymers thereof); styrene polymers and styrene copolymers; polycarbonate; silicones; polyimides; polysulfone; polyethersulfone; polyketones; polyether-ketones; polyphenylene sulfide; polyesters; polyethylene oxide; polyurethane; polyolefins; chlorinated or fluorinated polymers, and mixtures thereof.

Control device 70 can be made from the same or similar materials as those used to fabricate bottom surface 60. Control device 70 also may be integral with bottom surface 60, or be unitary with bottom surface 60. Control device 70 preferably includes control circuitry to control actuator 50. Control device 70 also preferably contains a source of electricity, such as a battery (lithium ion, alkaline, nickel, coin type battery, printable battery or the like) or solar powered battery, and a control circuit to provide pulses of current to actuator 50. Control device 70 preferably is capable of providing electrical current sufficient to provide a pull strength on the actuator 50 of from about 0.01 grams to about 10 grams, preferably from about 0.1 grams to about 5 grams, and more preferably from about 1 to about 4 grams. As a preferred embodiment, current applied at about 3.7 volts provides a 1 to 7 second duty cycle, in which duty cycle denotes one cycle of moving the interlaced images 40 from their initial position to a final position, and then back to the initial position. A rest cycle is not required, but if desired, the rest cycle can be adjusted from milliseconds to minutes. As will be appreciated by those having ordinary skill in the art, the duty cycle can be adjusted to suit the specific interlaced images 40, (e.g., more images may require a longer duty cycle), as well as to provide the desired effect (e.g., faster motion). For example, the duty cycle can range from about 1 second to about 2 minutes, or more preferably, from about 1 second to about 1 minute, and most preferably from about 1 second to about 20 seconds.

Control panel 70 may be modified either manually or remotely with wireless control, to modify the length and strength of the current, and consequently, modify the speed at which the images change on device 10. For example, the amount of current and/or the duration of current may be modified by turning knobs on control panel 70. Alternatively, the knobs may be turned remotely using a remote control.

Control panel 70 is electrically coupled to actuator 50. Electrically coupled in this context may include direct electronic attachment through circuitry, or wireless attachment. Actuator 50 may be electrically coupled directly to the power source present in control panel 70, or indirectly through one or more control elements that can control the amount, duration, and strength of current to deliver to actuator 50. Those skilled in the art will be capable of coupling actuator 50 to control panel 70 and adjust the circuitry of control panel 70 to provide the requisite movement to the one or more interlaced images 40, using the guidelines provided herein.

Actuator 50 preferably includes an electroactive polymer capable of expanding and/or contracting in response to electrical current. Other less preferred materials that could be used for actuator include springs, nitinol or shape memory alloys, simple electromagnetic rotor or motor to drive a piston back and forth, and the like. The inventor surprisingly has found that electroactive polymer actuators provide unexpectedly superior results with respect to reproducibility, energy efficiency, little to no heat generation, accuracy of movement, duration, and is more compact and cheaper than alternative actuators, such as nitinol and the like. Preferred embodiments of the invention therefore utilize an electroactive polymer actuator 50 to provide the requisite translational movement of the one or more interlaced images 40.

Embodiments of the invention therefore involve converting electrical energy into mechanical energy. However, in all the figures and discussions for the present invention, it is important to note that the polymers and devices may convert between electrical energy and mechanical energy bi-directionally. Thus, any of the polymer materials, polymer configurations, transducers, devices and actuators described herein are also a transducer for converting mechanical energy to electrical energy (a generator) in the reverse direction. Similarly, any of the exemplary electrodes described herein may be used with a generator. Typically, a generator includes a polymer arranged in a manner that causes a change in electric field in response to deflection of a portion of the polymer.

Electroactive polymers deflect when actuated by electrical energy. In one embodiment, an electroactive polymer refers to a polymer that acts as an insulating dielectric between two electrodes and may deflect upon application of a voltage difference between the two electrodes. In one aspect, the present invention relates to polymers that are pre-strained to improve conversion between electrical and mechanical energy. The pre-strain improves the mechanical response of an electroactive polymer relative to a non-strained electroactive polymer. The improved mechanical response enables greater mechanical work for an electroactive polymer, e.g., larger deflections and actuation pressures. For example, linear strains of at least about 200 percent and area strains of at least about 300 percent are possible with pre-strained polymers of the present invention. The pre-strain may vary in different directions of a polymer. Combining directional variability of the pre-strain, different ways to constrain a polymer, scalability of electroactive polymers to both micro and macro levels, and different polymer orientations (e.g., rolling or stacking individual polymer layers) permits a broad range of actuators that convert electrical energy into mechanical work. These actuators find use in a wide range of applications.

As the electroactive polymers of the present invention may deflect at linear strains of at least about 200 percent, electrodes attached to the polymers should also deflect without compromising mechanical or electrical performance. Correspondingly, in another aspect, the present invention relates to compliant electrodes that conform to the shape of an electroactive polymer they are attached to. The electrodes are capable of maintaining electrical communication even at the high deflections encountered with pre-strained polymers of the present invention. By way of example, strains at least about 50 percent are common with electrodes of the present invention. In some embodiments, compliance provided by the electrodes may vary with direction.

As the pre-strained polymers are suitable for use in both the micro and macro scales, in a wide variety of actuators and in a broad range of applications, fabrication processes used with the present invention vary greatly. Pre-strain may be achieved by a number of techniques such as mechanically stretching an electroactive polymer and fixing the polymer to one or more solid members while it is stretched. These polymers, stretched over rigid members, and positioned between electrodes, are capable of providing movement in a number of directions, and preferably back-and-forth in one plane. The electroactive polymers therefore are suitable to provide the displacement source in actuator 50, to enable actuator 50 to move the one or more interlaced images 40 back-and-forth to generate multiple images through lenticular lens 30.

Preferred actuators 50 include, for example, Electroactive Polymer Artificial Muscle (EPAM™) technology developed by SRI International and Artificial Muscle, Inc. Actuators that include the EPAM™ technology are commercially available from Artificial Muscle, Inc., Sunnyvale, Calif. EPAM™ technology operates by application of a voltage across two thin elastic film electrodes separated by an elastic dielectric polymer. When a voltage difference is applied to the electrodes, the oppositely-charged members attract each other producing pressure upon the polymer positioned between the electrodes. The pressure pulls the electrodes together, causing the dielectric polymer film to become thinner as it expands in the planar directions. Another factor drives the thinning and expansion of the polymer film. The like (same) charge distributed across each elastic film electrode causes the conductive particles embedded within the film to repel one another expanding the elastic electrodes and dielectric attached polymer film.

Diaphragm actuators can be fabricated by stretching an EPAM™ film over an opening in a frame. Known diaphragm actuator examples typically are biased (i.e., pushed in/out or up/down) directly by a spring, by an intermediate rod or plunger set between a spring and EPAM™, by resilient foam, or by air pressure. Biasing insures that the diaphragm will move in the direction of the bias upon electrode activation/thickness contraction rather than simply wrinkling. Suitable diaphragm actuators are disclosed in, for example, U.S. Pat. Nos. 7,521,840, 7,521,847, 7,595,580, 7,626,319, and 7,679,839, the disclosures of each of which is incorporated by reference herein in their entireties.

The electroactive polymer may be pre-strained or may not be pre-strained. Materials suitable for use as a pre-strained polymer with the present invention may include any substantially insulating polymer or rubber (or combination thereof) that deforms in response to an electrostatic force or whose deformation results in a change in electric field. One suitable material is NuSil CF19-2186 as provided by NuSil Technology of Carpenteria, Calif. More generally, exemplary materials suitable for use as a pre-strained polymer include silicone elastomers, acrylic elastomers, polyurethanes, thermoplastic elastomers, copolymers comprising PVDF, pressure-sensitive adhesives, fluoroelastomers, fluorosilicones, polymers comprising silicone and acrylic moieties, and the like. Polymers comprising silicone and acrylic moieties may include copolymers comprising silicone and acrylic moieties, polymer blends comprising a silicone elastomer and an acrylic elastomer, for example. Combinations of one or more of these materials may be used as the polymer in the actuator 50 of preferred embodiments of this invention.

One example of a suitable silicone elastomer is Dow Corning HS3 as provided by Dow Corning of Wilmington, Del. One example of a suitable fluorosilicone is Dow Corning 730 as provided by Dow Corning of Wilmington, Del. One suitable example of a thermoplastic elastomer is styrene butadiene styrene (SBS) block copolymer.

Some acrylics such as any acrylic in the 4900 VHB acrylic series as provided by 3M Corp. of St. Paul, Minn. have properties suitable for use as the transducer polymer for this invention. Thus, in some embodiments, polymers suitable for use with the present invention may be made from any monoethylenically unsaturated monomer (or combination of monomers) homopolymerizable to form a polymer having a glass transition temperature at most about 0° C. Preferred monoethylenically unsaturated monomers include isooctyl acrylate, 2-ethylhexyl acrylate, decyl acrylate, dodecyl acrylate, hexyl acrylate, isononyl acrylate, isooctyl methacrylate, and 2-ethylhexyl methacrylate. Any of the monomers may also include one or more halogens such as fluorine. One example of a suitable copolymer includes both silicone and acrylic elastomer moieties. In some case, materials suitable for use with the present invention may contain combinations of one or more of the above listed materials. For example, one suitable polymer is a blend including a silicone elastomer and an acrylic elastomer.

In many cases, materials used in accordance with the present invention are commercially available polymers. The commercially available polymers may include, for example, any commercially available silicone elastomer, polyurethane, PVDF copolymer and adhesive elastomer. Using commercially available materials provides cost-effective alternatives for transducers and associated devices of the present invention. The use of commercially available materials may also simplify fabrication. In a specific embodiment, the commercially available polymer is a commercially available acrylic elastomer comprising mixtures of aliphatic acrylate that are photocured during fabrication. The elasticity of the acrylic elastomer results from a combination of the branched aliphatic groups and cross-linking between the acrylic polymer chains.

Materials used as a pre-strained polymer may be selected based on one or more material properties such as a high electrical breakdown strength, a low modulus of elasticity—(for large or small deformations), a high dielectric constant, etc. In one embodiment, the polymer is selected such that is has an elastic modulus at most about 100 MPa. In another embodiment, the polymer is selected such that it has a maximum actuation pressure between about 0.05 MPa and about 10 MPa, and preferably between about 0.3 MPa and about 3 MPa. In another embodiment, the polymer is selected such that it has a dielectric constant between about 2 and about 20, and preferably between about 2.5 and about 12. For some applications, an electroactive polymer is selected based on one or more application demands such as a wide temperature and/or humidity range, repeatability, accuracy, low creep, reliability and endurance. Often, halogenated polymers, such as fluorinated or chlorinated polymers, exhibit a higher dielectric constant than the base polymer. In one example, a high dielectric polyurethane may be made from partially fluorinated urethane monomers.

Electroactive polymers of the present invention may also include one or more additives to improve various properties. Examples of suitable classes of materials include plasticizers, antioxidants, and high dielectric constant particulates. Examples of suitable plasticizers include high molecular-weight hydrocarbon oils, high molecular-weight hydrocarbon greases, Pentalyne H, Piccovar® AP Hydrocarbon Resins, Admex 760, Plastolein 9720, silicone oils, silicone greases, Floral 105, silicone elastomers, nonionic surfactants, and the like. Of course, combinations of these materials may be used. In one embodiment, the antioxidant is a nonvolatile solid antioxidant.

In one preferred embodiment, the additives improve the ability of the polymer to convert between mechanical energy and electrical energy. Generally, the additive may improve any polymer property or parameter related to the ability of the parameter to convert between mechanical energy and electrical energy. Polymer material properties and parameters related to the ability of the polymer to convert between mechanical energy and electrical energy include, for example, the dielectric breakdown strength, maximum strain, dielectric constant, elastic modulus, properties associated with the visco-elastic performance, properties associated with creep, response time and actuation voltage. The addition of a plasticizer may, for example, improve the functioning of a transducer of this invention by reducing the elastic modulus of the polymer and/or increasing the dielectric breakdown strength of the polymer.

In one embodiment, an additive is included in a polymer to improve the dielectric breakdown strength of the polymer. Improving the dielectric breakdown strength allows the use of larger electrically actuated strains for the polymer. By way of example, a plasticizing additive may be added to a polymer to increase the dielectric breakdown strength of the polymer. Alternatively, a synthetic resin may be added to a styrene-butadiene-styrene block copolymer to improve the dialectic breakdown strength of the copolymer. For example, pentalyn-H as produced by Hercules, Inc. of Wilmington, Del. was added to Kraton D2104 as produced by Shell Chemical of Houston, Tex. to improve the dialectic breakdown strength of the Kraton D2104. In this case, the ratio of pentalyn-H added may range from about 0 to 2:1 by weight. In another embodiment, an additive is included to increase the dielectric constant of a polymer. For example, high dielectric constant particulates such as fine ceramic powders may be added to increase the dielectric constant of a commercially available polymer. Alternatively, polymers such as polyurethane may be partially fluorinated to increase the dielectric constant.

Alternatively, an additive may be included in a polymer to reduce the elastic modulus of the polymer. Reducing the elastic modulus enables larger strains for the polymer. In a specific embodiment, mineral oil was added to a solution of Kraton D to reduce the elastic modulus of the polymer. In this case, the ratio of mineral oil added may range from about 0 to 2:1 by weight. Specific materials included to reduce the elastic modulus of an acrylic polymer of the present invention include any acrylic acids, acrylic adhesives, acrylics including flexible side groups such as isooctyl groups and 2-ethylhexyl groups, or any copolymer of acrylic acid and isooctyl acrylate.

Multiple additives may be included in a polymer to improve performance of one or more material properties. In one embodiment, mineral oil and pentalyn-H were both added to a solution of Kraton D2104 to increase the dielectric breakdown strength and to reduce the elastic modulus of the polymer. Alternatively, for a commercially available silicone rubber whose stiffness has been increased by fine carbon particles used to increase the dielectric constant, the stiffness may be reduced by the addition of a carbon or silver filled silicone grease.

An additive may also be included in a polymer to provide an additional property for the transducer. The additional property is not necessarily associated with polymer performance in converting between mechanical and electrical energy. By way of example, pentalyn-H may be added to Kraton D2104 to provide an adhesive property to the polymer. In this case, the additive also aids in conversion between mechanical and electrical energy. In a specific embodiment, polymers comprising Kraton D2104, pentalyn-H, mineral oil and fabricated using butyl acetate provided an adhesive polymer and a maximum linear strain in the range of about 70 to 200 percent.

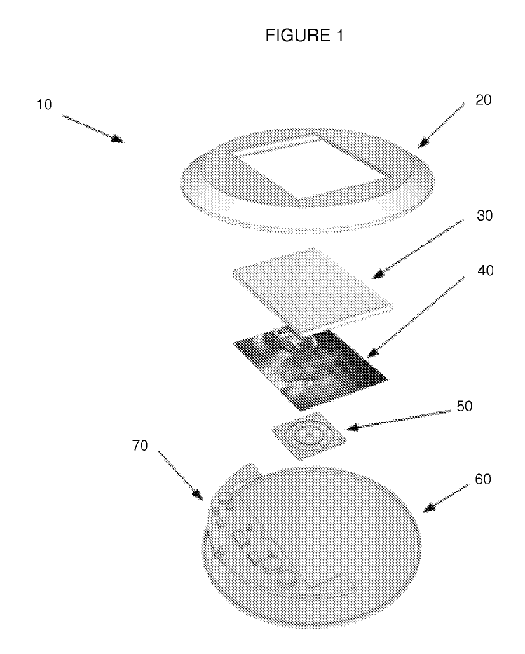

Suitable actuation voltages for pre-strained polymers of the present invention may vary based on the electroactive polymer material and its properties (e.g. the dielectric constant) as well as the dimensions of the polymer (e.g. the thickness between electrodes). By way of example, actuation electric fields for the actuator 50 in FIG. 1 may range in magnitude from about 0 V/m to about 440 MegaVolts/meter. Actuation voltages in this range may produce a pressure in the range of about 0 Pa to about 10 MPa. To achieve a transducer capable of higher forces, the thickness of the polymer may be increased. Alternatively, multiple polymer layers may be implemented. Actuation voltages for a particular polymer may be reduced by increasing the dielectric constant, decreasing polymer thickness and decreasing the modulus of elasticity, for example. For compact mass marketing multiple image display devices, it is preferred that that actuation voltage is low, and can be provided by a compact battery, such as a coin-type battery. These batteries generally provide voltages from about 1 V to about 5 V, and most preferably from about 2 V to 4 V.

Pre-strained polymers of the present invention may cover a wide range of thicknesses. In one embodiment, polymer thickness may range between about 1 micrometer and 2 millimeters. Typical thicknesses before pre-strain include 50-225 micrometers for HS3, 25-75 micrometers for NuSil CF 19-2186, 50-1000 micrometers for SBS, and 100-1000 microns for any of the 3M VHB 4900 series acrylic polymers. Polymer thickness may be reduced by stretching the film in one or both planar directions. In many cases, pre-strained polymers of the present invention may be fabricated and implemented as thin films. Thicknesses suitable for these thin films may be below 50 micrometers.

Actuators 50 that are capable of converting between mechanical and electrical energy useful in the embodiments also encompass multilayer laminates. In one embodiment, a multilayer laminate refers to a structure including one or more layers in addition to a single electroactive polymer and its corresponding electrodes. In one embodiment, a multilayer laminate refers to a structure having a transducer including an electroactive polymer and its corresponding electrodes, a layer laminated to at least one of the electrode and the polymer, and the layer mechanically coupled to a portion of the transducer. Multilayer laminates may be referred to as either external or internal. For external multilayer laminates, the one or more additional layers are not between the electrodes. For internal multilayer laminates, the one or more additional layers are between the electrodes. For either external or internal layers, the layers may be adhered using an adhesive or glue layer, for example.

Internal multilayer laminates may be used for a wide variety of purposes. A layer may also be included in an internal multilayer laminate to improve any mechanical or electrical property of the transducer, e.g., stiffness, electrical resistance, tear resistance, etc. Internal multilayer laminates may include a layer having a greater dielectric breakdown strength. Internal multilayer laminates may include multiple layers of compatible materials separated by conducting or semiconducting layers (e.g. metallic or polymer layers) to increase breakdown strength of the laminate transducer. Compatible materials refer to materials that comprise the same or substantially similar material or have the same or substantially similar properties (e.g. mechanical and/or electrical). Internal laminates of compatible materials relative to the polymer may be used to compensate for manufacturing defects in the polymer and provide greater transducer uniformity. By way of example, a 100 micrometer thick, single layer polymer may have a defect that may affect the entire 100 micrometer thickness. In this case, a laminate of ten layers each having a thickness of 10 micrometers may be used such that any manufacturing defects are localized to a 10 micrometer polymer—thus providing a comparable 100 micrometer thick laminate structure, but with greater uniformity and fault tolerance compared to the single layer polymer. Internal laminates of compatible materials relative to the polymer may also be used to prevent any runaway pull-in effect. Runaway pull-in effect refers to when the electrostatic forces between electrodes getting closer increases faster than the elastic resistive forces of the polymer. In such cases, the transducer may become electromechanically unstable, leading to rapid local thinning and electrical breakdown. An internal layer may also be used to afford a layer of protection (electrical or mechanical) to another layer in the composite. In one embodiment, an electrical barrier layer is mechanically coupled between an electrode and the polymer to minimize the effect of any localized breakdown in the polymer. Breakdown may be defined as the point at which the polymer cannot sustain the applied voltage. The barrier layer is typically thinner than the polymer and has a higher dielectric constant than the polymer such that the voltage drop mainly occurs across the polymer. It often is preferred that the barrier layer has a high dielectric breakdown strength.

External multilayer laminates may be used for a wide variety of purposes. In one embodiment, an external multilayer composite includes a layer to control stiffness, creep, to distribute load more uniformly during deflection, to increase tear resistance, or to prevent runaway pull effect. External laminates of compatible polymers including electrodes may be used to distribute load across each of the polymer layers or increase polymer uniformity during deflection. A layer may also be included in an external laminate having a higher stiffness than the polymer, e.g., a material having a higher stiffness or a different amount of pre-strain for a compatible material, to bias a diaphragm, pump or bending beam. In a generator mode, a stretched transducer may contract and generate electrical energy as long as the electrical field stresses are lower than the elastic restoring stresses. In this case, adding a stiffening layer may allow the transducer to contract against greater field stresses, thereby increasing its energy output per stroke. An external layer may also be used to afford a layer of protection (electrical or mechanical) to another layer in the composite. In another specific embodiment, an external composite includes a foam layer to bias a small pump or diaphragm. The foam layer may comprise an open pore foam that allows fluids to move in and out of the foam. An external layer having a low stiffness may also be used for electric shielding without introducing excessive mechanical energy loss.

While the relatively simple diaphragm actuator is a preferred actuator 50 for use in the embodiments, more complex actuators also may be utilized in the embodiments. For example, “inch-worm” and rotary output type devices can be used. Further description and details regarding the above-referenced devices as well as others may be found in the following patents and/or patent application publications, the disclosures of each of which are incorporated by reference herein in their entireties: U.S. Pat. Nos. 6,812,624, 6,809,462, 6,806,621, 6,781,284, 6,768,246, 6,707,236, 6,664,718, 6,628,040, 6,586,859, 6,583,533, 6,545,384, 6,543,110, 6,376,971, 6,343,129, and U.S. Patent Application Publication Nos. 2004/0217671, 2004/0263028, 2004/0232807, 2004/0217671, 2004/0124738, 2004/0046739, 2004/0008853, 2003/0214199, 2003/0141787, 2003/0067245, 2003/0006669, 2002/0185937, 2002/0175598, 2002/0175594, 2002/0130673, 2002/0050769, 2002/0008445, 2002/0122561, 2001/0036790, and 2001/0026165.

In a most preferred embodiment, actuator 50 can be designed to provide movement, preferably back-and-forth in one plane, of from 100 μm to 400 μm, more preferably from 150 μm to 350 μm, and even most preferably from 200 μm to 300 μm. Actuator 50 also preferably is designed and controlled via control panel 70 to provide this movement in from about 1 second to about 2 minutes, more preferably from about 3 seconds to about 1 minute, and most preferably about 10 seconds. Actuator 50 also preferably is designed and controlled via control panel 70 to provide a pull force to one or more interlaced images 40 of from about 1 gram to 20 grams of force, more preferably from about 2.5 grams to about 10 grams of force, and most preferably about 5 grams of force. Actuator 50 also is preferably designed to operate on a coin-type battery on a Voltage of about 3 volts, and can be from 1 to 5 mm thick, more preferably 2-4 mm thick.

In one preferred embodiment, a feature of the invention involves a specifically designed actuator 50 controlled via electric current through control panel 70 to provide motion in one direction, and then snapping back to the original position. This embodiment provides an improved device when compared to conventional lenticular devices that require images to be viewed in forward and reverse motion. The inventor has discovered that the snap back feature of the preferred embodiments provides an advantage in negating the need to create artwork that works both in forward and reverse directions as is the case with all traditional lenticular products. The snap-back feature functions by slowly going from the first image (or first position) to the last image (or final position) and then very quickly (in fractions of a second) returning (snapping back) to the first image. This sudden return to the first image is so fast that the human eye cannot distinguish all of the discrete images passing under the lens, thus allowing the device to play only in the forward or only in the reverse direction. This feature preferably is controlled by the current that is applied through the control circuitry to the EPAM actuator. This freature provides the flexibility of making versions that have a snap-back feature and versions that do not have a snap-back feature. The ability to snap-back can be controlled by how the current is applied to actuator 50 via control panel 70.

The one or more interlaced images 40 preferably is attached to actuator 50. By “attached,” the image(s) 40 can be physically attached directly to actuator 50, or may be attached through an intermediate member. Attachment may be by adhesive, screw, nail, brad, weld, thermoplastic melt attachment, or any other attachment mechanism known in the art. Attachment should be secure enough to enable the one or more interlaced image(s) 40 to move in the direction the actuator moves, without significant delay (although some delay may be designed into the device depending on the viewing attributes), and for extended periods of time. Preferably, the one or more interlaced image(s) 40 is attached to actuator 50 by mounting to a plastic back plate that is adhered to the output disc of actuator 50.

The one or more interlaced image(s) 40 can be made using one or more techniques known in the art for fabricating interlaced images. It is preferred that the individual images contained in the interlaced image(s) 40 depict movement of the subjects of the image as the image(s) 40 is displaced relative to the lenticular screen 30. For example, the images can depict a subject walking or running, or lifting a glass or can of beer, or playing a sporting event, such as throwing, catching or hitting a baseball, throwing, catching, or kicking a football, and the like. The image display will depend on the ultimate use of the device, and those skilled in the art will be capable of providing one or more interlaced image(s) 40, using the guidelines provided herein.

In one embodiment, the interlaced image(s) 40 can be made by a process that includes generating at least two images (objects) with a computer or other central processing unit (CPU). The first image can be produced by either creating original illustration/design or other graphic elements or by optically scanning or electronically reading the desired image (indicia) from a photograph, magazine, brochure, document, or other media and transmitting the image to a monitor or display screen of the CPU. The second image can be generated by electronically copying and subsequently altering and modifying the first image on the monitor, or it can be generated by a second original illustration/design or other graphic element. The second image, and any subsequent images can be photographs taken at various stages in the event or activity intended to be displayed. For example, a first image might include a photograph of a subject about to throw a ball, and the second image might include a photograph of a subject in the process of throwing the ball, and a third image might include a photograph of a subject completing the throw. When viewed one after the other, the images provide the illusion of a moving subject throwing a ball.

At least one and preferably all the images then can be masked, electrically revised and striped on the CPU by electronically removing erasing, cancelling, or otherwise deleting a symmetrical pattern of spaces on the images to from masked images with a spaced array of stripes comprising viewable opaque portions with spaces positioned between and separating the stripes.

After masking, part or all of the portions of the masked images are overlayed, superimposed, and combined upon each other in offset relationship so that the viewable stripes of one image are positioned in the spaces (spacer portions) of another image. The superimposed images or illustrations then can be printed on an underlying web or rearward web, (or webs, as the case may be) such as on coated backing paper. If desired, the web can be made of other materials, such as wood, metal, glass, composites, paper, paperboard, or cardboard, preferably or substantially planar or flat, flexible sheets.

The images also can be printed in black and white, or in different colors, if desired. The images can be words, letters, photographs, pictures, portraits, artwork, or be of different configurations and designs and can have indicia thereon, if desired.

The one or more images presented on the one or more interlaced image(s) 40 preferably are created to provide the viewer the illusion of movement. Thus, it is preferred that the timing of movement of one or more interlaced image(s) 40 relative to the lenticular screen 30 be considered in fabricating the image(s) 40. In one preferred embodiment, the interlaced image(s) 40 can be fabricated using a computerized system in which multiple images (each depicting, for example, movement in a series of images) are input into the system, the size and resolution is considered, as well as the amount of time each image is to be viewed by the viewer to provide the illusion of movement or video.

In a preferred embodiment, a computerized method for creating a multi-image print to be utilized with a dynamic display based on the relative periodic displacement of the multi-image print relative to a lenticular screen might include inputting into a computer data relating to the dynamic display, including its dimensions, form, lens characteristics and viewing angles. The method then might include inputting digital data of at least two basic images to be displayed and setting the size and resolution of the images to create basic documents. The method may further include determining the visual requirements of the basic documents relating to resolution, the exposure time of each image within a complete display cycle, and graphic characteristics, dividing each of the basic documents into small information units and interlacing the units into a single complex document. The method then preferably includes processing the complex document to meet the data and requirements input into the system, and then printing the complex document on one or more sheets to produce one or more interlaced images 40. The method provides one or more interlaced images 40 so that when the interlaced image(s) 40 is displaced relative to lenticular screen 30, the basic images will be alternatively displayed to provide the illusion of movement, like that seen in a video depiction.

Another preferred computerized method of generating one or more interlaced images 40 includes inputting the digital data of at least two basic images to be displayed and setting the size and resolution of said images to create basic documents. The method also includes inputting into a computer data relating to the dynamic display, including its dimensions, form, lens characteristics and viewing angles, and determining the visual requirements of the basic documents relating to resolution, the exposure time of each image within a complete display cycle, and graphic characteristics. The method further includes dividing each of the basic documents into small information units and interlacing the units into one or more complex documents, processing the one or more complex documents to meet the data and requirements input previously, and then printing the one or more complex documents on a sheet to produce the one or more interlaced images 40. When the one or more interlaced images 40 is displaced relative to lenticular screen 30, the discrete images will be alternatively displayed to provide the illusion of movement, like that seen in a video depiction.

One or more interlaced images(s) 40 may be fabricated using techniques known in the art. Various methods for generating interlaced images are known and described in, for example, U.S. Pat. Nos. 5,100,330, 5,364,274, 5,494,445 6,542,646, 7,079,279, 7,079,706, the disclosures of each of which is incorporated by reference herein in its entirety.

The device 10 of the preferred embodiments may include an interlaced image(s) 40 to provide two or more graphic images through lenticular screen 30 as the interlaced images 40 is moved relative to the screen 30. Two, three, four, or more images may be interlaced to create the interlaced image(s) 40, and then as interlaced image(s) 40 is moved incrementally with respect to lenticular screen 30, each image is viewed through the screen.

A lenticular lens 30 as used herein preferably is a sheet of transparent material having one side composed of a contiguous array of cylindrical lenses known as lenticules, and the other side being generally flat. U.S. Pat. No. 5,757,545, the disclosure of which is incorporated by reference herein in its entirety, discusses the structure of a lenticular lens. Lenticular images that are typically used in conjunction with the lenticular lenses are composite images composed of several different independent images interlaced into the same space, as described above.

An aspect of some embodiments of the invention relates to providing a weather-proof multi-image display device, for example a display device resistant to precipitation, condensation and/or extremes of temperature or solar illumination. In an exemplary embodiment, the display device 10 is designed to take into account the effect of heat fluctuations, for example by controlling the direction of expansion, by providing a same amount of expansion for the lenticular lens 30, one or more interlaced images 40, actuator 50, control panel 70 and bottom 60, by compensating for environment-related distortions. A temperature sensor may optionally be provided for modifying the actuator 50. Such a sensor may be incorporated into control panel 70. Alternatively or additionally, an internal heater (with an optional thermostat) may be included, for example for heating the housing 20, bottom 60, or other elements of the device 10. Such a heater may be, for example, a point heater or a surface heater, for example, a flat coil. For example, the display device 10 may be designed to withstand temperature ranges of 10° C., 20° C., 30° C., 40° C. or more, with temperature extremes, for example, of −20° C. and +40° C. Also high humidity levels and humidity level extremes may be supported, for example, 80%, 90% or high relative humidity and extremes from of less than 30% or 15% humidity to above 90% humidity.

The one or more interlaced images 40 may be positioned relative to lenticular lens 30 such that light from the sun does not focus on the display(s) 40, for example, the display(s) 40 being more than one or even two focal lengths away from lenticular lens 30. Displays 40 being positioned away from lenticular lens 30 increases the dimensions of the device, and typically are used when the size of device 10 is not important. For most personal uses (as opposed to billboards), however, the display(s) 40 are positioned directly behind lenticular lens 30. The present inventor has discovered that display(s) 40 positioned directly behind lenticular lens 30 or printed on the back-side of the lens as it is typically done for smaller devices, requires additional energy and may damage the image due to friction caused by contact with the lens 30. The present inventor therefore designed a lenticular lens 30 that reduces friction on the image plate/interlaced images 40. This reduction in drag/friction is preferred to compensate for the limited force generated by the electroactive polymer (EPAM) actuator 50. The lenticular lens 30 preferably is designed so that its focal point is adjusted by 200 microns (um) beyond the back of the lens (the flat side), which represents an improvement over conventional lenses in which the focal point of the lens is immediately behind the lens. This prevents unnecessary friction eliminating snags and binding of the interlaced images 40 as they are moved by the actuator behind the lens.

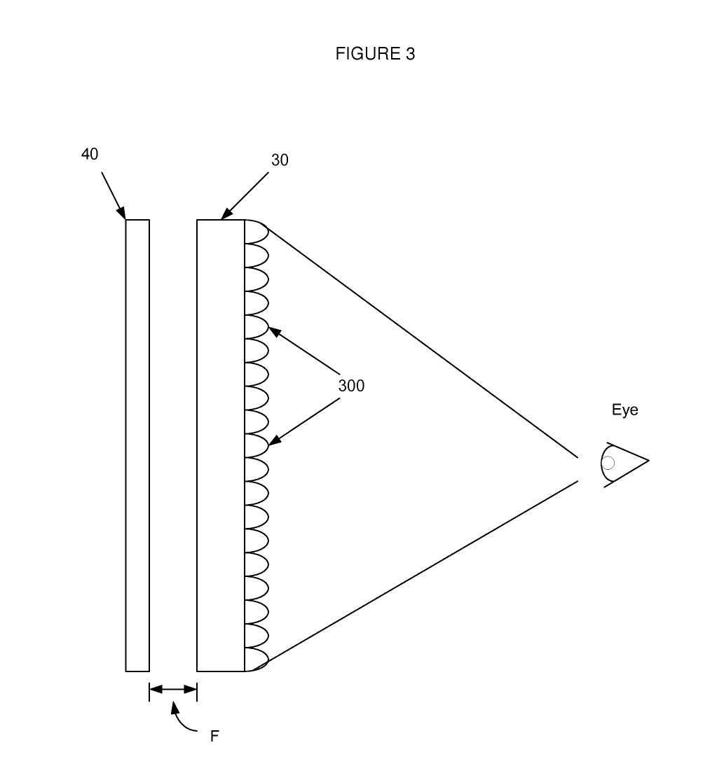

FIG. 3 illustrates a lenticular lens 30 that is preferred for use together with the electroactive polymer (EPAM) actuator 50. As shown in FIG. 3, the back side of the lenticular lens 30 has been modified so that the focal point F now is adjusted to between 50 microns to about 500 microns behind the flat side of the lens 30, more preferably from about 100 microns to about 300 microns, and most preferably about 200 microns beyond the back of, or flat side, of lenticular lens 30. The focal point F may be modified by altering the thickness of lenticular lens 30 or by modifying the dimensions of the individual lenticles 300 on the side of lens 30 facing the viewer's eye. The thickness of lenticular lens 30 can be modified by polishing, grinding, or otherwise removing a portion of the flat side of lenticular lens 30 that faces the interlaced image(s) 40. The inventors have found that the thickness of lenticular lens 30 can be slightly reduced to provide a slight gap that enables easier and relatively friction free movement of interlaced image(s) 40, yet still provide an image that is in focus and can be viewed by the viewer's eye. Persons having ordinary skill in the art will be capable of designing a suitable lenticular lens 30 having a gap between the lenticular lens 30 and interlaced image(s) 40, using the guidelines provided herein.

The lenticular lens 30 also may be provided with an anti-glare coating to reduce the intensity of incoming light. In addition, a light collimator may be provided to prevent light from impinging on the one or more interlaced images 40 from angles at which sunlight is expected. In an alternative embodiment, lenticular lens 30 may be formed with expansion holes or slot(s) to accommodate temperature expansion effects and/or to prevent condensation or allow it to escape.

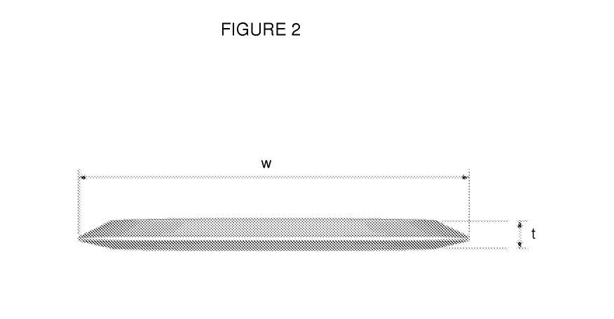

Device 10 preferably includes an outer housing 20, or casing, with a window to permit viewing therethrough. Lenticular lens 30 may be positioned beneath the window so that the images may be displayed. Window may be an open window, or may be glass, plastic, or other substantially transparent material. Housing 20 preferably encases all of the components of the device, and preferably is seamlessly connected to bottom surface 60 to provide a unitary object. When constructed, the device 10 may have the shape of a button, with a side profile shown in FIG. 2. Bottom 60 may be flat, or curved as shown in FIG. 2. For mass marketing devices intended to be attached to products, or worn by a subject, it is preferred that device 10 have a width (W) of from 25 to 500 mm, preferably from 50 to 250 mm, and even more preferably from 75 to 150 mm. It also is preferred that the device 10 have a thickness (t) of from about 1 mm to about 10 mm, preferably from 2 to 8 mm, and more preferably from 4 to 7 mm.

An additional feature of the invention includes a method of displaying multiple images from one or more interlaced displays comprising: (a) providing a device comprising a bottom surface, a control device positioned on or near the bottom surface, an actuator electrically coupled to the control device, the actuator comprised of at least one electroactive polymer capable of expanding or contracting in response to electrical current, one or more interlaced images attached to the actuator, and a lenticular lens positioned over the interlaced image(s); (b) providing current to the electroactive polymer to cause the polymer to expand and contract, whereby expansion and contraction of the polymer moves the one or more interlaced images relative to the lenticular lens to display multiple images through the lenticular lens.

The invention has been described with reference to particularly preferred embodiments. Those skilled in the art will appreciate that various modifications may be made to the invention without departing from the spirit and scope thereof.

What is claimed is:

1. A lenticular device comprising:
a bottom surface;
a control device positioned on or near the bottom surface;
an actuator electrically coupled to the control device, the actuator comprised of at least one electroactive polymer capable of expanding or contracting in response to electrical current;
one or more interlaced images attached to the actuator; and
a lenticular lens positioned over the interlaced image(s).

2. The lenticular device according to claim 1, wherein the control device provides electrical current to the actuator element in an amount within the range of from 1 Volt to about 5 Volts.

3. The lenticular device according to claim 2, wherein the current is within the range of from about 2 Volts to about 4 Volts.

4. The lenticular device according to claim 1, wherein the actuator expands or contracts to move the interlaced images in one plane from about 100 μm to 400 μm.

5. The lenticular device according to claim 4, wherein the interlaced images are moved in one plane in an amount within the range of from about 200 μm to 300 μm.

6. The lenticular device according to claim 1, wherein the control device moves the interlaced images in a period of time within the range of from about 1 second to about 2 minutes.

7. The lenticular device according to claim 6, wherein the control device moves the interlaced images in a period of time within the range of from about 3 seconds to about 1 minute.

8. The lenticular device according to claim 1, wherein the control device moves the interlaced images and returns the images to their original position over a period of time ranging from about 1 second to about 2 minutes.

9. The lenticular device according to claim 8, wherein the control device moves the interlaced images and returns the images to their original position over a period of time ranging from about 1 second to about 20 seconds.

10. The lenticular device according to claim 1, wherein the control device moves the interlaced images in one direction over a period of time ranging from about 1 second to about 20 seconds, and then returns the interlaced images to their original position in less than one second.

11. The lenticular device according to claim 1, wherein the actuator is a diaphragm actuator.

12. The lenticular device according to claim 1, wherein the one or more interlaced images are positioned about 50 μm to about 500 μm behind the lenticular lens.

13. The lenticular device according to claim 12, wherein the one or more interlaced images are positioned about 100 μm to about 300 μm behind the lenticular lens.

14. A method of displaying multiple discrete images from one or more interlaced images comprising:
(a) providing a device comprising a bottom surface, a control device positioned on or near the bottom surface, an actuator electrically coupled to the control device, the actuator comprised of at least one electroactive polymer capable of expanding or contracting in response to electrical current, one or more interlaced images attached to the actuator, and a lenticular lens positioned over the interlaced image(s);
(b) providing current to the electroactive polymer to cause the polymer to expand and contract, whereby expansion and contraction of the polymer moves the one or more interlaced images relative to the lenticular lens to display multiple images through the lenticular lens.

15. The method as claimed in claim 14, wherein current is provided to the electroactive polymer in an amount within the range of from about 2 Volts to about 4 Volts.

16. The method as claimed in claim 14, wherein the interlaced images are moved relative to the lenticular lens in one plane in amount of from about 200 μm to 300 μm.

17. The method as claimed in claim 14, wherein the interlaced images are moved in one plane and returned to their original position in a period of time within the range of from about 1 second to about 20 seconds.

18. The method as claimed in claim 14, wherein the interlaced images are moved in one direction over a period of time ranging from about 1 second to about 20 seconds, and then returned to their original position in less than one second.
